(19) United States
(12) Patent Application Publication
(10) Pub. No.: US 2016/0178832 A1
(43) Pub. Date: Jun. 23, 2016

(54) BACKLIGHT MODULE, TRANSPARENT DISPLAY PANEL AND TRANSPARENT DISPLAY APPARATUS

(71) Applicant: SHENZHEN CHINA STAR OPTOELECTRONICS TECHNOLOGY CO., LTD., Shenzhen, Guangdong (CN)

(72) Inventors: Yu-Chun Hsiao, Shenzhen, Guangdong (CN); Shih Hsiang Chen, Shenzhen, Guangdong (CN); Guofu Tang, Shenzhen, Guangdong (CN); Quan Li, Shenzhen, Guangdong (CN); Chengling Lv, Shenzhen, Guangdong (CN); Chaofan Guo, Shenzhen, Guangdong (CN)

(21) Appl. No.: 14/418,778

(22) PCT Filed: Dec. 30, 2014
(86) PCT No.: PCT/CN2014/095490

§ 371 Date: Jan. 30, 2015

(30) Foreign Application Priority Data
Dec. 22, 2014 (CN) 201410811422.7

(51) Int. Cl. F21V 8/00; G02F 1/133; G02F 1/1333

(52) U.S. Cl. CPC G02B 6/0066; G02F 1/13338; G02F 1/13318; G02B 6/0025

(57) ABSTRACT

A backlight module, a transparent display panel and a transparent display apparatus provided comprises a edge-lit light source for providing incident light, a transparent scattering plate for scattering the incident light from the edge-lit light source and an external environment, a transparent light-guiding plate for guiding the direction of the light, a controller for adjusting the edge-lit light source according to the intensity of the light from the external environment. The scattering plate and the transparent light-guiding plate both receive the light from the built-in edge-lit light source and the environmental light for improving light utilization.

### FIELD OF THE INVENTION

The present invention relates to the technical field of liquid crystal display technology, and in particular to a backlight module, a transparent display panel, and a transparent display apparatus.

### BACKGROUND OF THE INVENTION

Recently, people are actively researching transparent display technology. Transparent displays have a certain degree of transmittance, can display the background behind the screen, and are suitable for architecture, vehicle windows, and shop windows. In addition to the existing display function, transparent displays also have the features of future displays, such as providing information, therefore attract attention of the market, and may replace part of the market of display usage, including applications to architecture, advertisements, and other public areas.

In the basic structure of existing transparent displays, a backlight source is added to a side of a transparent light-guiding plate, and then combined with a liquid crystal panel. However, the upper polarizing plate and the lower polarizing plate used in the existing transparent display are typically linear polarizing plates. In the electrode structure, the liquid crystal disclination phenomenon is prone to occur on the electrode edges and the inflection points, and liquid crystal molecules cannot be deflected at this time, so that the linear polarized light through the lower polarizing plate cannot be deflected after passing through the liquid crystal layer, the polarization direction of the linear polarized light remains unchanged, and the linear polarized light is finally directly absorbed by the upper polarizing plate, thereby reducing the light transmittance of the transparent display.

Meanwhile, many display products are designed based on the applications of the transparent displays. Improving technical support to the transparent display apparatus from the display elements is particularly important.

### SUMMARY OF THE INVENTION

In view of this, a backlight module, a transparent display panel, and a transparent display apparatus are provided in the present invention in order to solve the problem of poor light transmittance in the prior art.

To solve the above technical problem, the following technical solutions are provided in the embodiments of the present invention:

A backlight module comprising:

an edge-lit light source for providing incident light;

a scattering plate being transparent for scattering the incident light from the edge-lit light source and an external environment;

a light-guiding plate being transparent for guiding the direction of the incident light; and

a controller connected to the edge-lit light source, and adjusting the edge-lit light source according to the intensity of the incident light from the external environment.

Preferably, the incident angle and the intensity of the edge-lit light source are adjusted by the controller.

Preferably, the edge-lit light source and the light-guiding plate are in an identical horizontal line or vertical line, and the edge-lit source completely surrounds the light-guide plate.

Preferably, the scattering plate comprises a plurality of scattering particles, there are gaps between the scattering particles for the incident light to transmit, and the surfaces of the scattering particles are used for reflecting the incident light of the edge-lit light source.

To solve the above technical problem, the following technical solutions are provided in the embodiments of the present invention:

A transparent display panel comprising:

a backlight module including an edge-lit light source, a transparent scattering plate for scattering incident light from the edge-lit light source and an external environment, and a

transparent light-guiding plate;

a liquid crystal cell; and

a controller connected to the liquid crystal cell, and the side-light source for generating and sending control signals, which comprises adjusting the edge-lit light source according to the intensity of the incident light from the external environment, and adjusting rotation of liquid crystals in the liquid crystal cell.

Preferably, the transparent display panel further comprises a touch plate attached to the liquid crystal cell for receiving a touch command and transmitting the same to the controller.

Preferably, the controller adjusts the intensity of the light from the edge-lit light source by changing the incident angle and/or the intensity.

Preferably, the edge-lit light source and the light-guiding plate are in an identical horizontal line or vertical line, and the edge-lit source completely surrounds the light-guide plate.

Preferably, the scattering plate comprises a plurality of scattering particles, there are gaps between the scattering particles for transmitting the incident light, and the surfaces of the scattering particles are used for reflecting the incident light of the edge-lit light source.

Preferably, the transparent display panel further comprises a photosensitive element for sensing the intensity of the incident light from the external environment, and for informing the controller.

Preferably, when the photosensitive element senses that the intensity of the light from the external environment is lower than a first predetermined threshold, the controller adjusts the edge-lit light source for enhancing the brightness of the transparent display panel; or

when the photosensitive element senses that the intensity of the light from the external environment is higher than a second predetermined threshold, the controller adjusts the edge-lit light source for lowering the brightness of the transparent display panel.

Preferably, the photosensitive element is further used for sensing the color intensity of the light incident from the external environment, and for informing the controller.

Preferably, when the photosensitive element senses that the color intensity of a color of the light from the external environment is higher than a third predetermined threshold, the controller adjusts the rotation of the liquid crystal in the liquid crystal cell to avoid the color with the excessive intensity; or

when the photosensitive element senses that the color intensity of a color of the light from the external environment is lower than a forth predetermined threshold, the controller adjusts the rotation of the liquid crystal in the liquid crystal cell to preferably choose the color with insufficient intensity.

To solve the above technical problem, the following technical solutions are provided in the embodiments of the present invention:

A transparent display apparatus, comprising the transparent display panel described above.

With respect to the prior art, the scattering plate and the transparent light-guiding plate in the present invention both receive the light from the built-in edge-lit light source and the environmental light for improving light utilization.

### BRIEF DESCRIPTION OF THE DRAWINGS

The following briefly introduces the accompanying drawings used in the embodiments. Obviously, the drawings in the following description merely show some of the embodiments of the present invention. As regards one of ordinary skill in the art, other drawings can be obtained in accordance with these accompanying drawings without making creative efforts.

FIG. 1 is a structural schematic diagram of a backlight module in accordance with embodiment 1 of the present invention;

FIG. 2 is a structural schematic diagram of a transparent display panel in accordance with embodiment 2 of the present invention;

FIG. 3 is a structural schematic diagram of a transparent display apparatus in accordance with embodiment 3 of the present invention.

### DETAILED DESCRIPTION OF THE PREFERRED EMBODIMENTS

Please refer to the figures in the accompany drawings. The components with the same reference numbers represent the same or similar components. The following description is based on the illustrated specific embodiments of the present invention, and should not be construed to limit the other specific embodiments which are not described in detail herein.

### Embodiment 1

Refer to FIG. 1, which is a structural schematic diagram of a backlight module in the present invention. The backlight module 10 comprises an edge-lit light source 11, a scattering plate 12, a light-guiding plate 13, and a controller 14. The scattering plate 12, and the light-guiding plate 13 are composed of a transparent material.

The edge-lit light source 11 is used for providing incident light. The incident angle and/or the intensity of the edge-lit light source 11 can be adjusted. The adjustment is based on control signals from the controller 14.

It should be understood that the intensity of the incident light provided by the edge-lit light source 11 and the change of the incident angle will directly affect the proportion of external light. That is, the transparent display apparatus manufactured from the backlight module provided by the present invention technically supports real-time alteration in need of highlighting external information or highlighting display information.

The edge-lit light source 11 and the light-guiding plate 13 are in the identical horizontal line or vertical line, and the edge-lit source 11 completely surrounds the light-guide plate 13. Such an arrangement is used for forming a preset angle with the scattering plate 12. The position arrangement of the two makes the incident range of the scattering plate 12 wider. Moreover, the edge-lit source completely surrounds the light-guide plate, rather than from a single side, making the incident light provided more even and the display results better.

It should be understood that the luminescent result of the edge-lit light source 11 directly affects the visual result of the liquid crystal display after assembly.

The scattering plate 12 is transparent for scattering the incident light from the edge-lit light source 11 and incident light from an external environment.

It should be appreciated that the scattering plate 12 comprises a plurality of scattering particles 120, there are gaps between the scattering particles 120 for transmitting the incident light, and the surfaces of the scattering particles 120 are used for reflecting the incident light of the edge-lit light source 11. The scattering plate 12 and the scattering particles 120 can be the same material, or can be different materials. The scattering particles 120 can be transparent metal particles.

The light-guiding plate 13 is transparent for guiding the direction of the incident light.

The controller 14 connected to the edge-lit light source 11, and adjusting the edge-lit light source 11 according to the intensity of the incident light from the external environment.

The liquid crystal display (LCD) apparatus is a non-luminescent display apparatus, and requires the support from the backlight module to achieve a display function. In addition to the backlight module performance directly influencing the quality of the display apparatus, the cost of the backlight module accounts for 30-50% of the liquid crystal display apparatus, and the power consumed by the backlight module accounts for about 75% of the liquid crystal display apparatus. The backlight module can be considered as a very important member in the liquid crystal display apparatus.

The backlight module 10 in the present invention is used as an important member in the liquid crystal display apparatus, and not only has a light and thin structure and high transparency, but also has the advantages of high brightness and low power consumption due to its transparent properties and scattering effect on the built-in light source.

### Embodiment 2

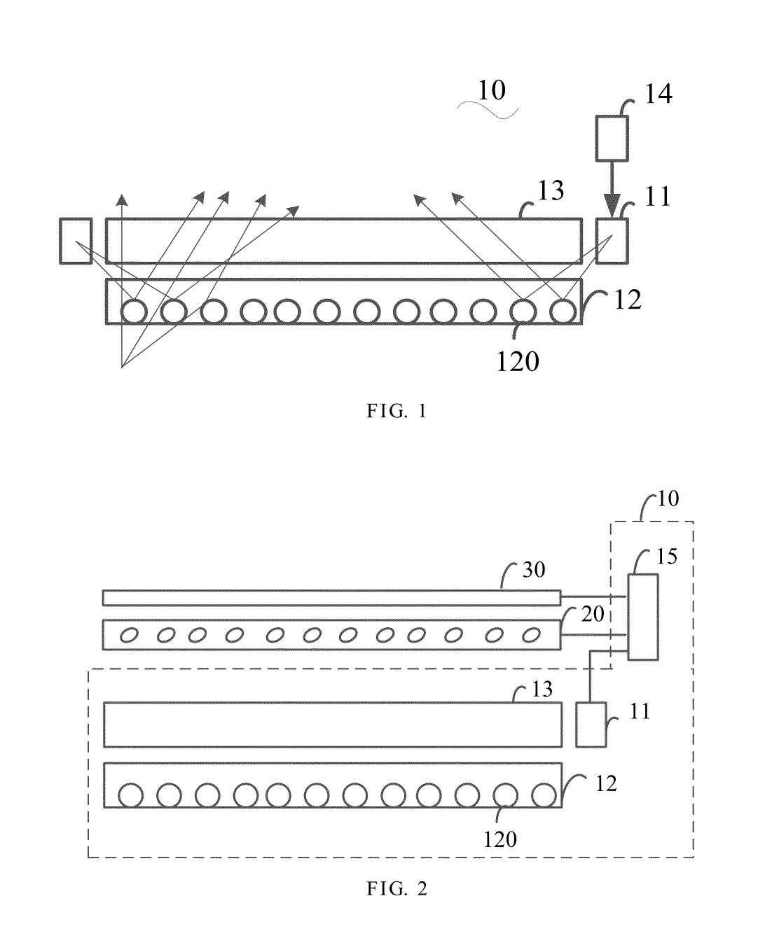

Refer to FIG. 2, which is a structural schematic diagram of a transparent display panel in the present invention. The transparent display panel comprises a backlight module 10, and a liquid crystal cell 20, and may further comprise a touch panel 30.

In particular, the backlight module 10 comprises an edge-lit light source 11, a scattering plate 12, a light-guiding plate 13, and a controller 15.

The edge-lit light source 11 is used for providing the incident light. The incident angle and/or the intensity of the edge-lit light source 11 can be adjusted. The adjustment is based on control signals from the controller 15.

It should be understood that the intensity of the incident light provided by the edge-lit light source 11 and the change of the incident angle will directly affect the proportion of external light. That is, the transparent display apparatus manufactured from the backlight module provided by the present invention technically supports real-time alteration in need of highlighting external information or highlighting display information.

The edge-lit light source 11 and the light-guiding plate 13 are in an identical horizontal line or vertical line, and the edge-lit source 11 completely surrounds the light-guide plate 13. Such an arrangement is used for forming a preset angle with the scattering plate 12. The position arrangement of the two makes the incident range of the scattering plate 12 wider. Moreover, the edge-lit source completely surrounds the light-guide plate, rather than from a single side, making the incident light provided more even and the display results better.

It should be understood that the luminescent result of the edge-lit light source 11 directly affects the visual result of the liquid crystal display after assembly.

The scattering plate 12 is transparent for scattering the incident light from the edge-lit light source 11 and incident light from an external environment.

It should be appreciated that the scattering plate 12 comprises a plurality of scattering particles 120, there are gaps between the scattering particles 120 for transmitting the incident light, and the surfaces of the scattering particles 120 are used for reflecting the incident light of the edge-lit light source 11. The scattering plate 12 and the scattering particles 120 can be the same material, or can be different materials. The scattering particles 120 can be transparent metal particles.

The light-guiding plate 13 is transparent for guiding the direction of the incident light.

The liquid crystal cell 20 can be attached by the touch panel 30 on the liquid crystal cell 20, and attached by the light-guiding plate 13 and the scattering plate 12 of the backlight module 10 under the liquid crystal cell 20. It should be understood that the “on” refers to the direction close to the user, and “under” refers to a direction close to the light source. It should be understood that the liquid crystal cell 20 itself is not luminescent. The graphics or characters displayed by the liquid crystal cell 20 are the results of adjustments to the light thereof.

The scattering plate 12, the light-guiding plate 13, and the liquid crystal cell 20 are all composed of transparent materials.

The controller 15 is connected to the liquid crystal cell 20 and the edge-lit light source 11 for generating and sending control signals, which comprises adjusting the edge-lit light source according to the intensity of the incident light from the external environment, and adjusting rotation of liquid crystals in the liquid crystal cell.

The controller further comprises a photosensitive element, for sensing the intensity and color of the incident light from the external environment. It can be summarized as four kinds of situations:

(1) When the photosensitive element senses that the intensity of the light from the external environment is lower than a first predetermined threshold, the controller adjusts the edge-lit light source for enhancing the brightness of the transparent display panel.

(2) When the photosensitive element senses that the intensity of the light from the external environment is higher than a second predetermined threshold, the controller adjusts the edge-lit light source for lowering the brightness of the transparent display panel.

(3) When the photosensitive element senses that color the intensity of a color of the light from the external environment is higher than a third predetermined threshold, the controller adjusts the rotation of the liquid crystal in the liquid crystal cell to avoid the color with the excessive intensity.

(4) When the photosensitive element senses that the color intensity of a color of the light from the external environment is lower than a forth predetermined threshold, the controller adjusts the rotation of the liquid crystal in the liquid crystal cell to preferably choose the color with the insufficient intensity.

For example, in front of a blue object, if the display information still remains blue, it may be mixed with the background, and cannot be recognized easily. By analyzing the color intensity of the color, information of different colors or even opposite colors is automatically generated, bringing better recognition results. It should be understood that if the color is opposite, a slightly lower brightness can be used to display, and meanwhile an energy saving effect can further be achieved.

The touch pad 30 is attached on the liquid crystal cell 20 for receiving a touch command and transferring the same to the controller 15.

It should be understood that the touch panel 30 can be used as a supplement to the photosensitive element described above, which is convenient for customers sometimes to display content not being necessarily entirely transparent and not having equal emphasis on display information, but having bias emphasis, such as, on an object or information needed to be seen in the external environment.

The touch pad 30 is an optional element, and other control means can also be used, such as a side installation button of the display panel.

The transparent display in the present invention has not only a light and thin structure and high transparency, but also the advantages of high brightness and low power consumption, due to its transparent properties and scattering effect on the built-in light source.

### Embodiment 3

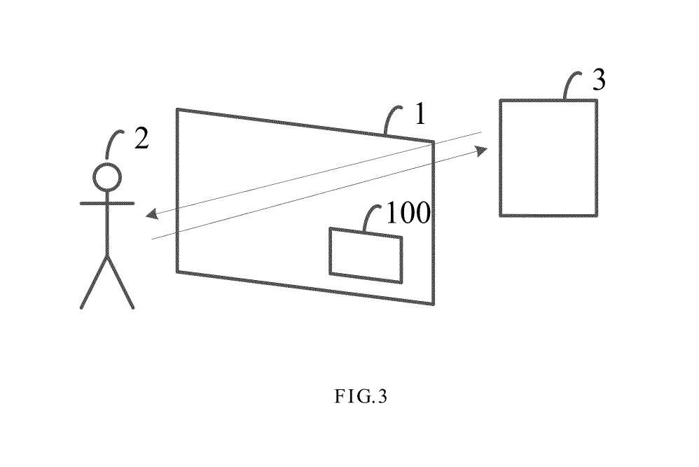

FIG. 3 is a structural schematic diagram of a transparent display apparatus in accordance with embodiment 3 of the present invention.

A transparent display apparatus 1 comprises the backlight module of embodiment 1 and/or the transparent display panel of the embodiment 2, and has advantages of a light and thin structure, high transparency, high brightness, and low power consumption.

The transparent display apparatus 1 is adjusted to appropriate brightness and color according to an external environment, and displays information, which is mixed with an object 3 in a background, with more balanced brightness and color for use of an observer 2.

Furthermore, the transparent display apparatus 1 supports the observer 2 to modify the balanced brightness and color on the transparent display apparatus 1 according to demand for highlighting the object 3 in the background or highlighting display information 100.

It should be understood that though various embodiments have different emphases, the designing concepts are the same. For the parts which are not described in detail in a certain embodiment, please refer to the detailed description in the full text of the specification, which are not described redundantly.

In summary, although the preferable embodiments of the present invention have been disclosed above, the embodiments are not intended to limit the present invention. A person of ordinary skill in the art, without departing from the spirit and scope of the present invention, can make various modifications and variations. Therefore, the scopes of the invention are defined in the claims.

What is claimed is:

1. A backlight module, comprising:
an edge-lit light source for providing incident light;
a scattering plate being transparent for scattering incident light from the edge-lit light source and an external environment;
a light-guiding plate being transparent for guiding the direction of the incident light; and
a controller connected to the edge-lit light source, and adjusting the edge-lit light source according to the intensity of the incident light from the external environment.

2. The backlight module according to claim 1, wherein the incident angle and the intensity of the edge-lit light source are adjusted by the controller.

3. The backlight module according to claim 1, wherein the edge-lit light source and the light-guiding plate are on an identical horizontal line or vertical line, and the edge-lit light source completely surrounds the light-guide plate.

4. The backlight module according to claim 1, wherein the scattering plate comprises a plurality of scattering particles, there are gaps between the scattering particles for the incident light to transmit, and the surfaces of the scattering particles are used for reflecting the incident light of the edge-lit light source.

5. A transparent display panel, comprising:
a backlight module including an edge-lit light source, a transparent scattering plate for scattering incident light from the edge-lit light source and an external environment, and a
transparent light-guiding plate;
a liquid crystal cell; and
a controller connected to the liquid crystal cell and the edge-lit light source for generating and sending control signals, which comprises adjusting the edge-lit light source according to the intensity of the incident light from the external environment, and adjusting rotation of liquid crystals in the liquid crystal cell.

6. The transparent display panel according to claim 5, further comprising a touch panel attached to the liquid crystal cell for receiving a touch command and transmitting the same to the controller.

7. The transparent display panel according to claim 5, wherein the controller adjusts the intensity of the light from the edge-lit light source by changing the incident angle and/or the intensity.

8. The transparent display panel according to claim 5, wherein the edge-lit light source and the light-guiding plate are in an identical horizontal line or vertical line, and the edge-lit source completely surrounds the light-guide plate.

9. The transparent display panel according to claim 5, wherein the scattering plate comprises a plurality of scattering particles, there are gaps between the scattering particles for the incident light to transmit, and the surfaces of the scattering particles are used for reflecting the incident light of the edge-lit light source.

10. The transparent display panel according to claim 5, further comprising a photosensitive element for sensing the intensity of the incident light from the external environment, and for informing the controller.

11. The transparent display panel according to claim 10, wherein when the photosensitive element senses that the intensity of the light from the external environment is lower than a first predetermined threshold, the controller adjusts the edge-lit light source for enhancing the brightness of the transparent display panel; or when the photosensitive element senses that the intensity of the light from the external environment is higher than a second predetermined threshold, the controller adjusts the edge-lit light source for lowering the brightness of the transparent display panel.

12. The transparent display panel according to claim 11, wherein the photosensitive element is further used for sensing the color intensity of the light incident from the external environment, and for informing the controller.

13. The transparent display panel according to claim 11, wherein
when the photosensitive element senses that color the intensity of a color of the light from the external environment is higher than a third predetermined threshold, the controller adjusts the rotation of the liquid crystal in the liquid crystal cell to avoid the color with the excessive intensity; or
when the photosensitive element senses that the color intensity of a color of the light from the external environment is lower than a forth predetermined threshold, the controller adjusts the rotation of the liquid crystal in the liquid crystal cell to preferably choose the color with the insufficient intensity.

14. A transparent display apparatus, comprising the transparent display panel according to any of claims 5-13.
